(19) United States
(12) Patent Application Publication
(10) Pub. No.: US 2026/0205344 A1
(43) Pub. Date: Jul. 16, 2026

(54) NON-UNIFORM CONSTELLATION DESIGN

(71) Applicant: QUALCOMM Incorporated, San Diego, CA (US)

(72) Inventors: Yinhua JIA, Beijing (CN); Changlong XU, Beijing (CN); Liangming WU, Beijing (CN); Wei LIU, Beijing (CN); Hao XU, Beijing (CN)

(21) Appl. No.: 19/136,042

(22) PCT Filed: Jan. 25, 2023
(86) PCT No.: PCT/CN2023/073469

§ 371 Date: Jun. 5, 2025

(51) Int. Cl. H04L 27/36

(52) U.S. Cl. CPC H04L 27/36

(57) ABSTRACT

Various aspects of the present disclosure generally relate to wireless communication. In some aspects, a transmitting device may select constellation points for a first non-uniform constellation (NUC) design from among constellation points for a uniform constellation of a modulation order. The transmitting device may order bits for the selected constellation points. The transmitting device may generate NUC information that includes the selected constellation points and the ordered bits. The transmitting device may transmit the NUC information. Numerous other aspects are described.

### FIELD OF THE DISCLOSURE

Aspects of the present disclosure generally relate to wireless communication and to techniques and apparatuses for designing non-uniform constellations.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a transmitting device. The method may include selecting constellation points for a first non-uniform constellation (NUC) design from among constellation points for a uniform constellation of a modulation order. The method may include ordering bits for the selected constellation points. The method may include generating NUC information that includes the selected constellation points and the ordered bits. The method may include transmitting the NUC information.

Some aspects described herein relate to a method of wireless communication performed by a receiving device. The method may include receiving NUC information that includes ordered bits and coordinates for constellation points selected for a first NUC design from among constellation points for a uniform constellation of a modulation order. The method may include transmitting or receiving a communication using the first NUC design.

Some aspects described herein relate to a transmitting device for wireless communication. The transmitting device may include a memory and one or more processors coupled to the memory. The one or more processors may be configured to select constellation points for a first NUC design from among constellation points for a uniform constellation of a modulation order. The one or more processors may be configured to order bits for the selected constellation points. The one or more processors may be configured to generate NUC information that includes the selected constellation points and the ordered bits. The one or more processors may be configured to transmit the NUC information.

Some aspects described herein relate to a receiving device for wireless communication. The receiving device may include a memory and one or more processors coupled to the memory. The one or more processors may be configured to receive NUC information that includes ordered bits and coordinates for constellation points selected for a first NUC design from among constellation points for a uniform constellation of a modulation order. The one or more processors may be configured to transmit or receive a communication using the first NUC design.

Some aspects described herein relate to a non-transitory computer-readable medium that stores a set of instructions for wireless communication by a transmitting device. The set of instructions, when executed by one or more processors of the transmitting device, may cause the transmitting device to select constellation points for a first NUC design from among constellation points for a uniform constellation of a modulation order. The set of instructions, when executed by one or more processors of the transmitting device, may cause the transmitting device to order bits for the selected constellation points. The set of instructions, when executed by one or more processors of the transmitting device, may cause the transmitting device to generate NUC information that includes the selected constellation points and the ordered bits. The set of instructions, when executed by one or more processors of the transmitting device, may cause the transmitting device to transmit the NUC information.

Some aspects described herein relate to a non-transitory computer-readable medium that stores a set of instructions for wireless communication by a receiving device. The set of instructions, when executed by one or more processors of the receiving device, may cause the receiving device to receive NUC information that includes ordered bits and coordinates for constellation points selected for a first NUC design from among constellation points for a uniform constellation of a modulation order. The set of instructions, when executed by one or more processors of the receiving device, may cause the receiving device to transmit or receive a communication using the first NUC design.

Some aspects described herein relate to an apparatus for wireless communication. The apparatus may include means for selecting constellation points for a first NUC design from among constellation points for a uniform constellation of a modulation order. The apparatus may include means for ordering bits for the selected constellation points. The apparatus may include means for generating NUC information that includes the selected constellation points and the ordered bits. The apparatus may include means for transmitting the NUC information.

Some aspects described herein relate to an apparatus for wireless communication. The apparatus may include means for receiving NUC information that includes ordered bits and coordinates for constellation points selected for a first NUC design from among constellation points for a uniform constellation of a modulation order. The apparatus may include means for transmitting or receiving a communication using the first NUC design.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of a quadrature amplitude modulation constellation, in accordance with the present disclosure.

FIGS. 5A and 5B are diagrams illustrating examples of constellation schemes, in accordance with the present disclosure.

FIG. 6 is a diagram illustrating an example of communication capacities, in accordance with the present disclosure.

FIG. 7 is a diagram illustrating an example of a flow chart for non-uniform constellation (NUC) design, in accordance with the present disclosure.

FIG. 8 is a diagram illustrating an example associated with using an NUC design for a modulation order, in accordance with the present disclosure.

FIG. 9 is a diagram illustrating an example of an NUC design search, in accordance with the present disclosure.

FIG. 10 is a diagram illustrating an example of bit reordering, in accordance with the present disclosure.

FIG. 11 is a diagram illustrating examples of NUC look-up tables, in accordance with the present disclosure.

FIG. 12 is a diagram illustrating an example of NUC generation, in accordance with the present disclosure.

FIG. 13 is a diagram illustrating an example process performed, for example, by a transmitting device, in accordance with the present disclosure.

FIG. 14 is a diagram illustrating an example process performed, for example, by a receiving device, in accordance with the present disclosure.

FIG. 15 is a diagram of an example apparatus for wireless communication, in accordance with the present disclosure.

### DETAILED DESCRIPTION

Quadrature amplitude modulation (QAM) is a digital modulation scheme where data is transmitted over a channel by varying both the amplitude and phase of a high-frequency carrier signal. The transmitted signal is represented in a quadrant grid known as a constellation map, which has two orthogonal axes, the in-phase and quadrature. In the QAM scheme, two or more bits are grouped together to form a symbol that lies as a point in a constellation. Each symbol (state) has a unique amplitude and phase level that provides distinction across different points in the constellation. In a uniform constellation, each point is equally spaced from other points. Each point has multiple bits for the modulation.

Constellation shaping can improve upon conventional QAM by modifying the uniform distribution of the data symbols to match the channel. Modifying the uniform distribution may include forming a non-uniform constellation (NUC) for the modulation order, where one or more points are not equally spaced from other points. However, existing NUC designs in un-constrained QAM cannot be applied to 3GPP networks directly and consume substantial processing resources and signaling resources.

According to various aspects described herein, a transmitting device may generate an NUC design from a uniform modulation, such as a uniform constellation of a QAM. NUC points may be selected from a subset of the uniform points, such as from 25% of the uniform points. The transmitting device may indicate the NUC design (e.g., via a look-up table (LUT)) to a receiving device. The transmitting device and the receiving device may communicate using the NUC design. By selecting NUC points from among the uniform points, including fewer NUC points than the uniform points, the transmitting device may improve communications while conserving processing resources and signaling resources.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

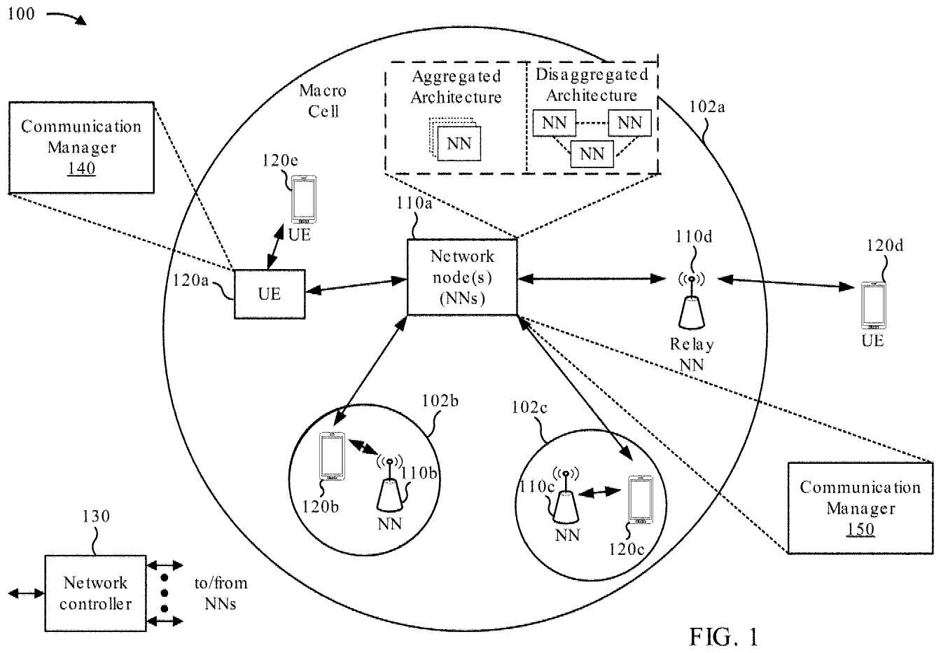

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a transmitting device (e.g., UE 120, network node 110) may include a communication manager 140 or 150. As described in more detail elsewhere herein, the communication manager 140 or 150 may select constellation points for a first non-uniform constellation (NUC) design from among constellation points for a uniform constellation of a modulation order. The communication manager 140 or 150 may order bits for the selected constellation points. The communication manager 140 or 150 may generate NUC information that includes the selected constellation points and the ordered bits. The communication manager 140 or 150 may transmit the NUC information. Additionally, or alternatively, the communication manager 140 or 150 may perform one or more other operations described herein.

In some aspects, a receiving device (e.g., network node 110, UE 120) may include a communication manager 140 or 150. As described in more detail elsewhere herein, the communication manager 140 or 150 may receive NUC information that includes ordered bits and coordinates for constellation points selected for a first NUC design from among constellation points for a uniform constellation of a modulation order. The communication manager 140 or 150 may transmit or receive a communication using the first NUC design. Additionally, or alternatively, the communication manager 140 or 150 may perform one or more other operations described herein.

As indicated above, FIG. 1 is provided as an example. Other examples may differ from what is described with regard to FIG. 1.

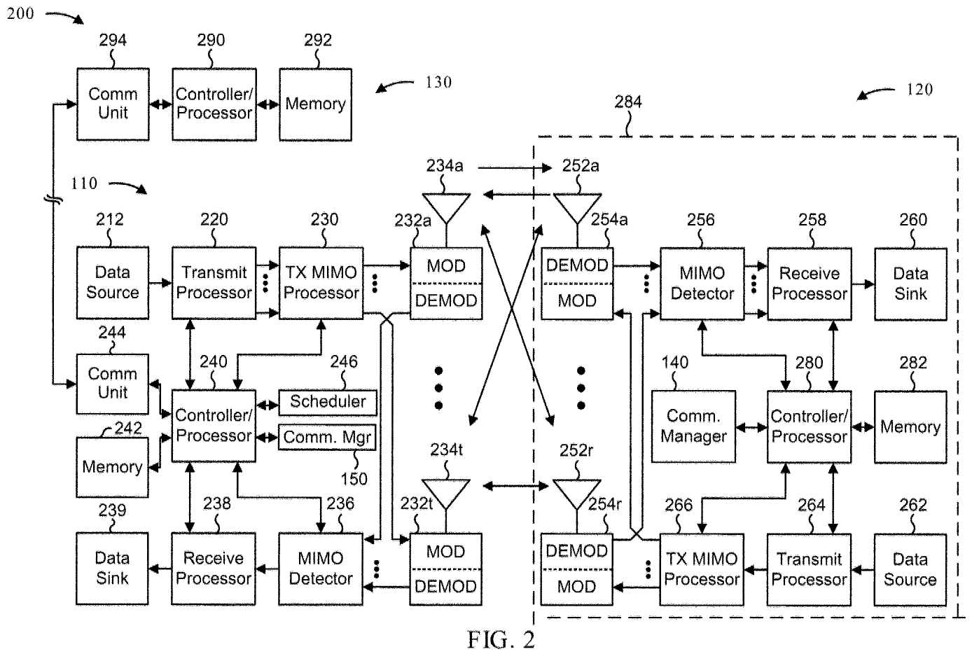

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

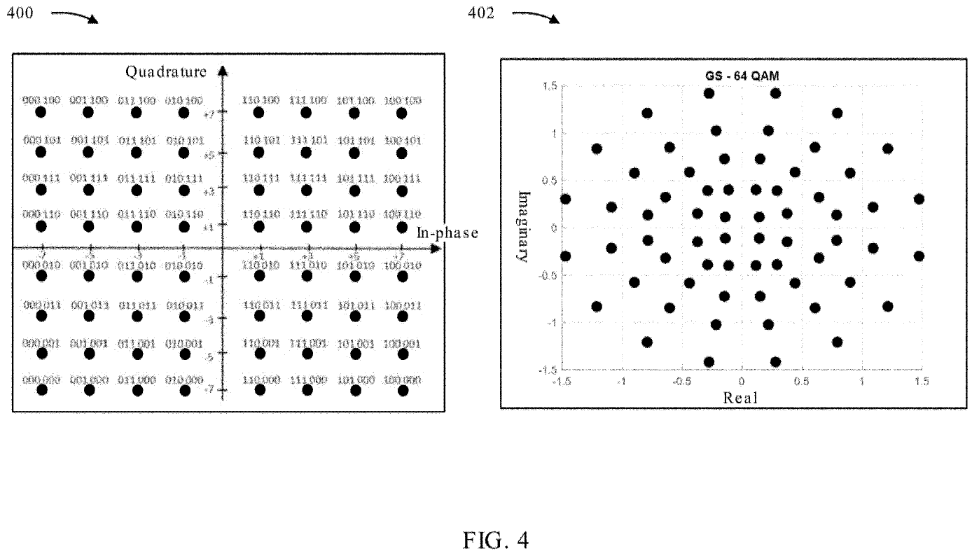

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-15).

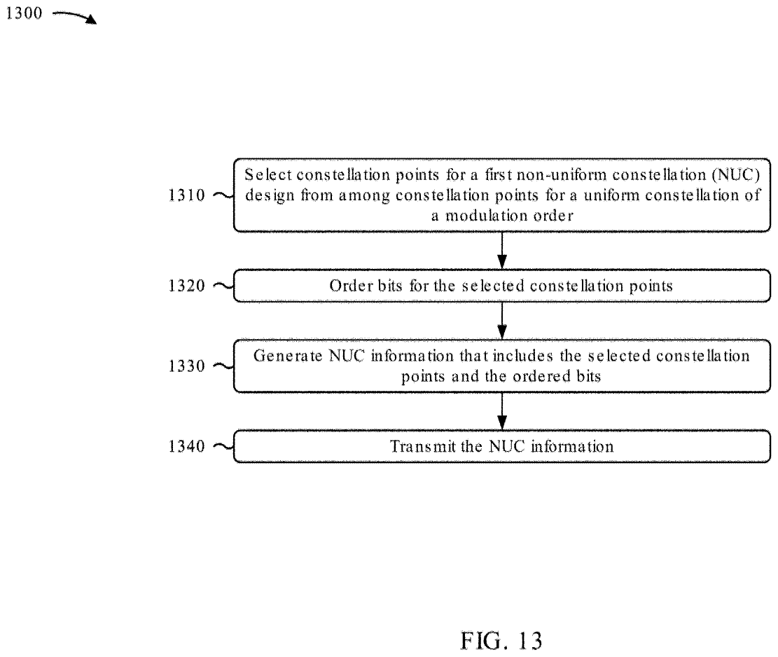

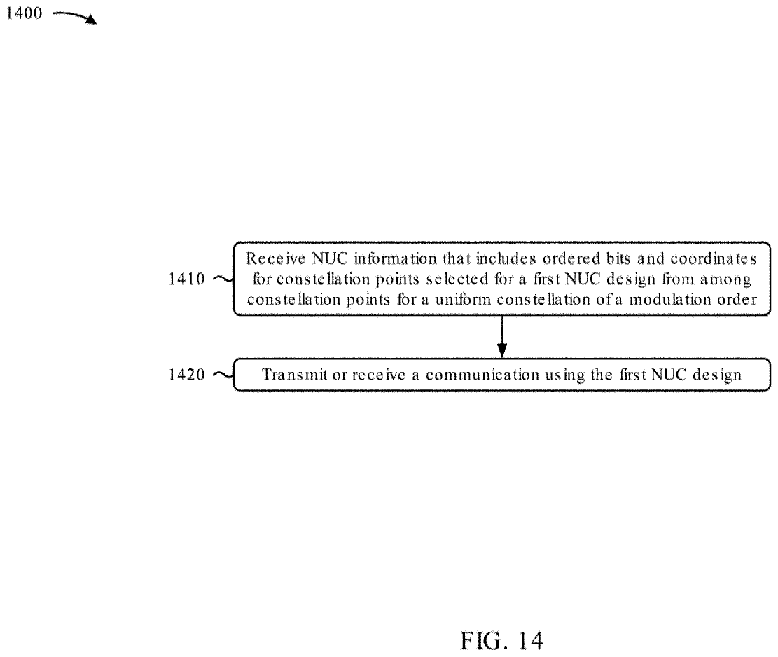

The controller/processor 240 of the network node 110, the controller/processor 280 of the UE 120, and/or any other component(s) of FIG. 2 may perform one or more techniques associated with designing an NUC for a modulation order, as described in more detail elsewhere herein. In some aspects, the transmitting device and the receiving device described herein is a network node 110, is included in the network node 110, or includes one or more components of the network node 110 shown in FIG. 2. In some aspects, the transmitting device and the receiving device described herein is the UE 120, is included in the UE 120, or includes one or more components of the UE 120 shown in FIG. 2. For example, the controller/processor 240 of the network node 110, the controller/processor 280 of the UE 120, and/or any other component(s) of FIG. 2 may perform or direct operations of, for example, process 1300 of FIG. 13, process 1400 of FIG. 14, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, a transmitting device (e.g., UE 120, network node 110) includes means for selecting constellation points for a first NUC design from among constellation points for a uniform constellation of a modulation order; means for ordering bits for the selected constellation points; means for generating NUC information that includes the selected constellation points and the ordered bits; and/or means for transmitting the NUC information. In some aspects, the means for the transmitting device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the transmitting device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a receiving device (e.g., network node 110, UE 120) includes means for receiving NUC information that includes ordered bits and coordinates for constellation points selected for a first NUC design from among constellation points for a uniform constellation of a modulation order; and/or means for transmitting or receiving a communication using the first NUC design. In some aspects, the means for the receiving device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the receiving device to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

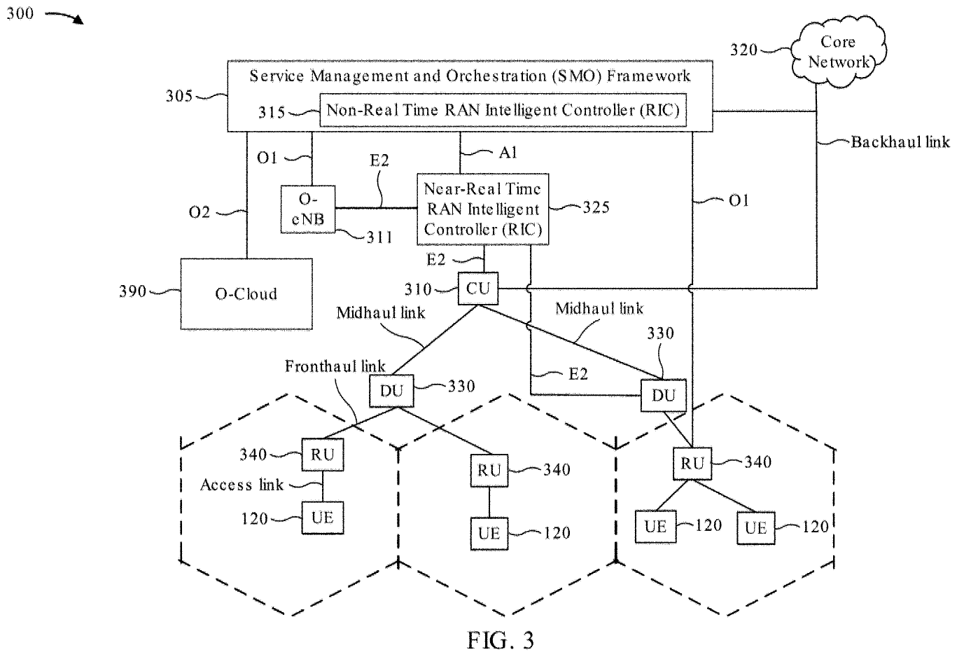

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating examples 400 and 402 of a QAM constellation, in accordance with the present disclosure.

QAM is a digital modulation scheme where data is transmitted over a channel by varying both the amplitude and phase of a high-frequency carrier signal. The transmitted signal is represented in a quadrant grid known as a constellation map, which has two orthogonal axes, the in-phase and quadrature. In the QAM scheme, two or more bits are grouped together to form a symbol that lies as a point in a constellation. Each symbol (state) has a unique amplitude and phase level that provides distinction across different points in the constellation. Example 400 shows a uniform constellation for 64 QAM with 64 constellation points, where each point is equally spaced from other points. Each point has multiple bits for the modulation.

Constellation shaping can be used to enhance digital signal modulation. Constellation shaping can improve upon amplitude and phase-shift keying (APSK) and conventional QAM by modifying the uniform distribution of the data symbols to match the channel. Modifying the uniform distribution may include forming an NUC, where one or more points are not equally spaced from other points. Types of constellation shaping may include geometric shaping and probabilistic shaping. Geometric shaping may result in a one-dimensional (1D) NUC or a two-dimensional (2D) NUC. Example 402 shows a 1D NUC constellation for 64 QAM. Geometric shaping may include searching for NUC constellation points via numeric, heuristic, and/or machine learning approaches. Geometric shaping may include higher demodulation complexity and lower gain than probabilistic shaping.

Probabilistic shaping may include targeting a distribution and/or targeting a minimal transmit power. Probabilistic shaping may achieve capacity by tuning a signal-to-noise ratio (SNR)-specific symbol distribution. For example, the distribution may be a Maxwell-Boltzman distribution with P(a)=e^{-λa}^{²} for a∈A, where A is a constellation alphabet set, and a is one symbol alphabet of the A.

As indicated above, FIG. 4 is provided as an example. Other examples may differ from what is described with regard to FIG. 4.

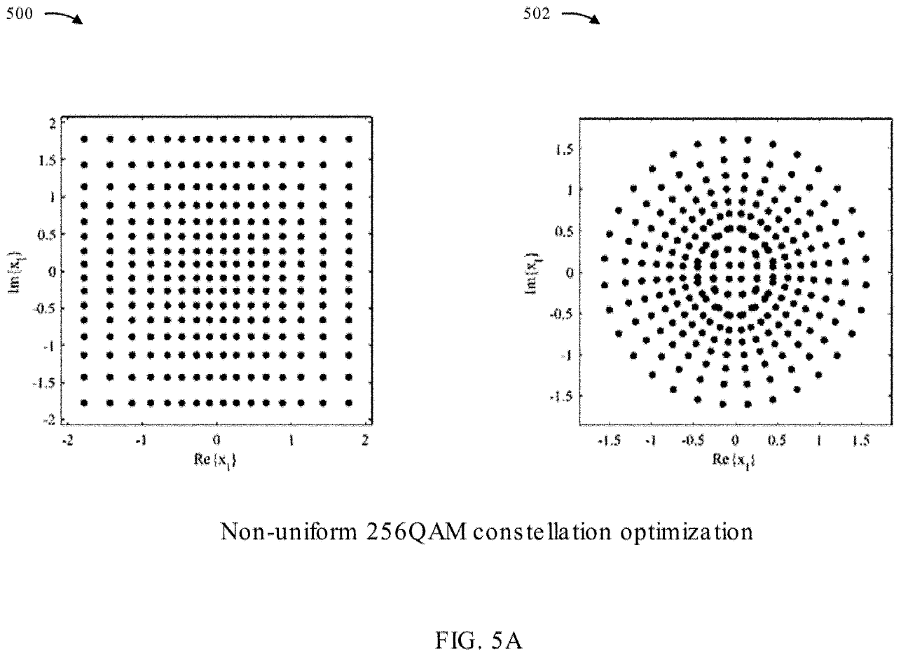

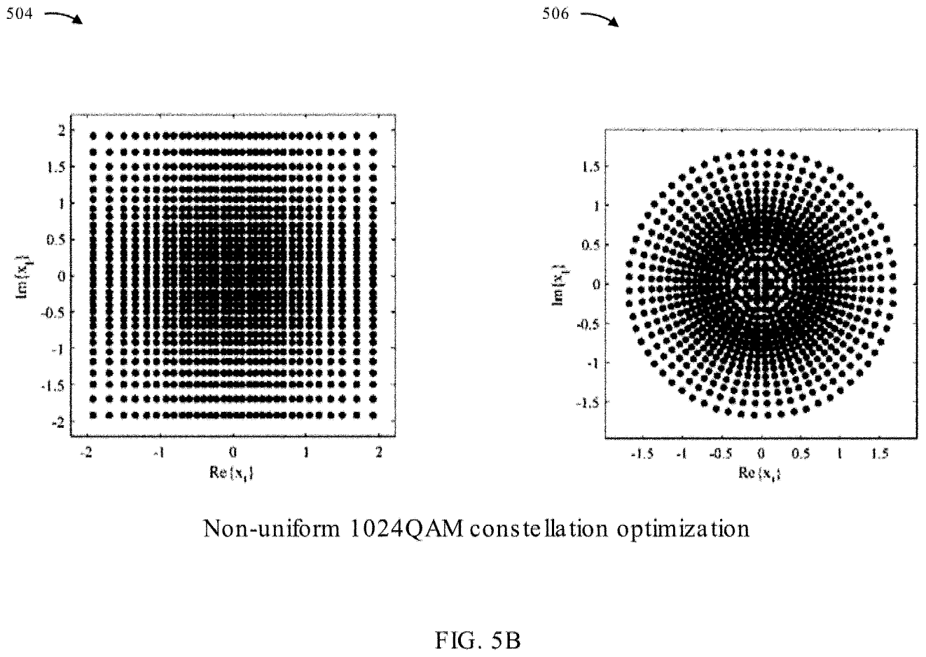

FIGS. 5A and 5B are diagrams illustrating examples 500, 502, 504, and 506 of constellation schemes, in accordance with the present disclosure.

Some NUC designs may use, for example, a gradient-search procedure that includes searching for 64, 256, or 1024 NUC points. A gradient search may involve a first-order iterative optimization algorithm for finding a local minimum of a differentiable function, where repeated steps are taken in the opposite direction of the gradient of the function at the current point (direction of steepest descent). FIG. 5A includes example 500 that shows a 1D NUC for 256 QAM, and example 502 that shows a 2D NUC for 256 QAM. FIG. 5B includes example 504 that shows a 1D NUC for 1024 QAM and example 506 that shows a 2D NUC for 1024 QAM. Information for the constellation points may be stored in an LUT, where each constellation point is associated with an index, an in-phase value, and a quadrature value. The constellation point may be associated with a quantity of bits that is based on a quantity of decimal places for a value.

As indicated above, FIGS. 5A and 5B are provided as examples. Other examples may differ from what is described with regard to FIGS. 5A and 5B.

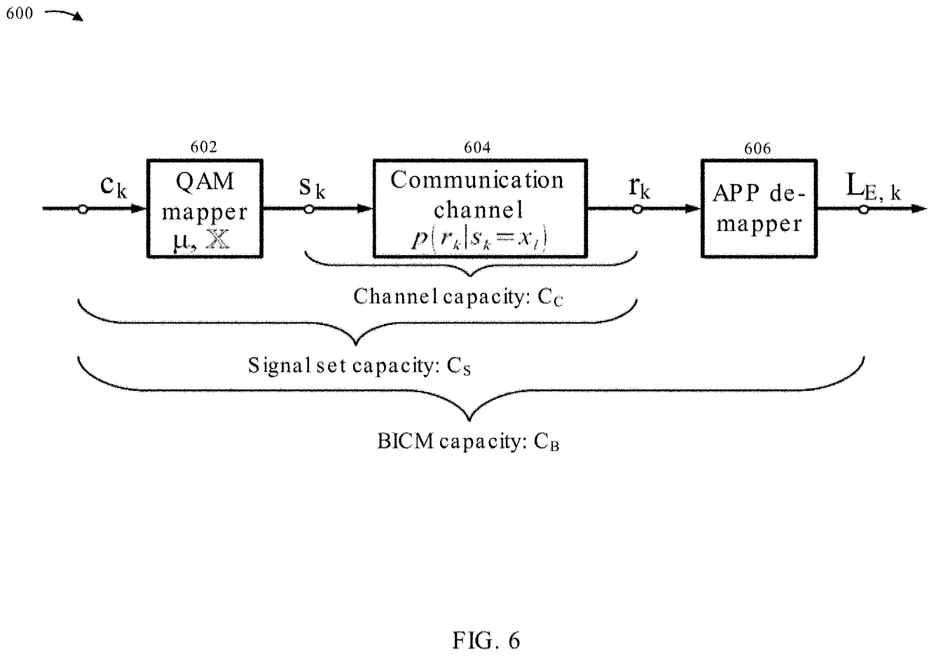

FIG. 6 is a diagram illustrating an example 600 of communication capacities, in accordance with the present disclosure.

Block components of a system for QAM modulation may include a QAM mapper 602 that modulates data cₖ for k constellation points and transmits modulated data sₖ for a communication channel 604. An application (APP) de-mapper 606 de-maps the received data rₖ and outputs unmodulated data L_{E,k}. The communication channel 604 may have a channel capacity C_{C}, which can be referred to as an “unconstrained Shannon limit” of communication channels. The QAM mapper 602 and the communication channel 604 may have a signal set capacity C_{S}, and the QAM mapper 602, the communication channel 604, and the APP de-mapper 606 may have a base-interleaved coded modulation (BICM) capacity C_{B}, where C_{C}>C_{S}>C_{B}. C_{S} may use a multi-level decoder. Example 600 shows example representations of the signal set capacity C_{S} and the BICM capacity C_{B}.

Factors that affect C_{B} include the constellation position and the bit labeling. In practice, the achievable capacity is the BICM capacity. Different BICM capacities may have different point positions and different bit labeling that are associated with a maximum achievable rate. In some aspects, an NUC may be designed by optimizing C_{B} with transmit power constraints.

However, existing NUC designs in un-constrained QAM cannot be applied to 3GPP networks directly, because such procedures are not aligned with existing 3GPP standards. The LUT storage of existing NUC designs is too large. For existing NUC designs, there is only one scheme for each modulation order, which is not robust for modulation order switching. Existing NUC designs have no pattern and the de-mapper complexity is high. In other words, existing NUC designs consume substantial processing resources and signaling resources.

As indicated above, FIG. 6 is provided as an example. Other examples may differ from what is described with regard to FIG. 6.

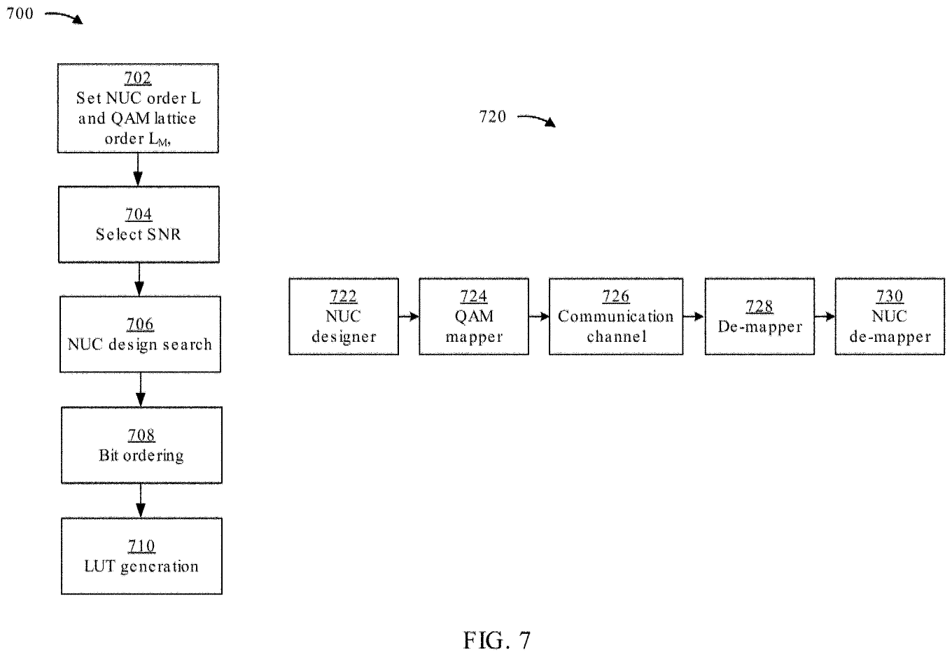

FIG. 7 is a diagram illustrating an example 700 of a flow chart for NUC design, in accordance with the present disclosure.

According to various aspects described herein, a transmitting device may generate an NUC design from a uniform modulation, such as a uniform constellation of a QAM. In some aspects, the NUC design may be generated via preprocessing and/or post-processing modules in an NR system, including by a QAM mapper, and processing via an APP de-mapper. The transmitting device may leverage the merit of a uniformed QAM constellation by using a low complexity de-mapper and searching for constellation points of a target NUC from among constellation points of a larger uniformed QAM constellation. The NUC design may also be generated using one or more additional components, such as an NUC designer component. NUC points may be selected from a subset of the uniform points, such as from 25% of the uniform points. In some aspects, the current transceiver may use the QAM symbol, and the NUC symbol may be obtained with minimal change by selection from the QAM lattice. The transmitting device may indicate the NUC design (e.g., via an LUT) to a receiving device. The transmitting device and the receiving device may communicate using the NUC design. By selecting NUC points from among the uniform points, including fewer NUC points than the uniform points, the transmitting device may improve communications while conserving processing resources and signaling resources.

The transmitting device may generate the NUC design based at least in part on the BICM capacity. As the BICM capacity may vary with different bit labelling, the transmitting device may select bit labelling for a more effective and/or more efficient NUC design. With a system low-density parity check (LDPC) encoder, high performance bits may be set as system bits such that bits are reordered based at least in part on bit performance. System bits may be used for parameter channel encoding, and coded bits may be segmented into systematic bits (part of coded bits that are equal to input bits) or parity bits. The first or second bits with the highest performance may become system bits after bit reordering. There may be minimum changes for the modulation when re-using the NR LDPC as much as possible.

Example 700 shows an example process for generating an NUC design. As shown by reference number 702, the transmitting device may set an NUC order L and a QAM constellation (lattice) order L_{M}. The NUC order L may be less than the QAM lattice order L_{M}. For example, L for the NUC design may be a target of 64 constellation points from among 1024 constellation points for L_{M}.

As shown by reference number 704, the transmitting device may select an SNR for the NUC design. The SNR may be selected based at least in part on a capability of the transmitting device and a capability of the receiving device. The SNR may be based at least in part on traffic conditions and/or channel conditions. The transmitting device may design multiple NUCs for multiple SNRs for the same modulation order.

As shown by reference number 706, the transmitting device may perform an NUC design search. This may include searching for constellation points to include in the NUC design from among constellation points of a uniform constellation of a modulation order. In some aspects, the transmitting device may search a subset (e.g., 25%, 50%) of the placement positions and select NUC points with bit-labeling. The NUC points may be randomly searched, and thus the NUC points may not be symmetrical with respect to the axes. The transmitting device may apply symmetry to the NUC point positions. This may include adjusting coordinates such that the points are symmetrical with respect to the axes.

As shown by reference number 708, the transmitting device may order bits for NUC points. This may include bit-labeling points and reordering any bits based on bit performance. As shown by reference number 710, the transmitting device may generate an LUT that includes coordinates and bits for indexed points. The transmitting device may transmit the LUT in NUC information.

As shown by reference number 720, there may be multiple components that are involved with generating and using an NUC design. The transmitting device may include NUC designer 722 and QAM mapper 724. The NUC designer 722 may perform the NUC design search and select the constellation points for an NUC design. The QAM mapper 724 may map data to the constellation points of the NUC design and label bits at the constellation points. The transmitting device may transmit NUC information that indicates the NUC design. The transmitting device may use the NUC design to transmit a communication (e.g., modulated data) over the communication channel 726.

A receive device may receive the communication. The APP de-mapper 728 (e.g., at the receiving device) may de-map the communication to obtain locations for modulated data in the communication. In some aspects, the NUC de-mapper 730 may be used to de-map the communication for an NUC design, including for an NUC design with fewer constellation points than an associated uniform constellation for a modulation order. Functionality may be combined into a component and/or additional components configured for NUC designs may be used.

As indicated above, FIG. 7 is provided as an example. Other examples may differ from what is described with regard to FIG. 7.

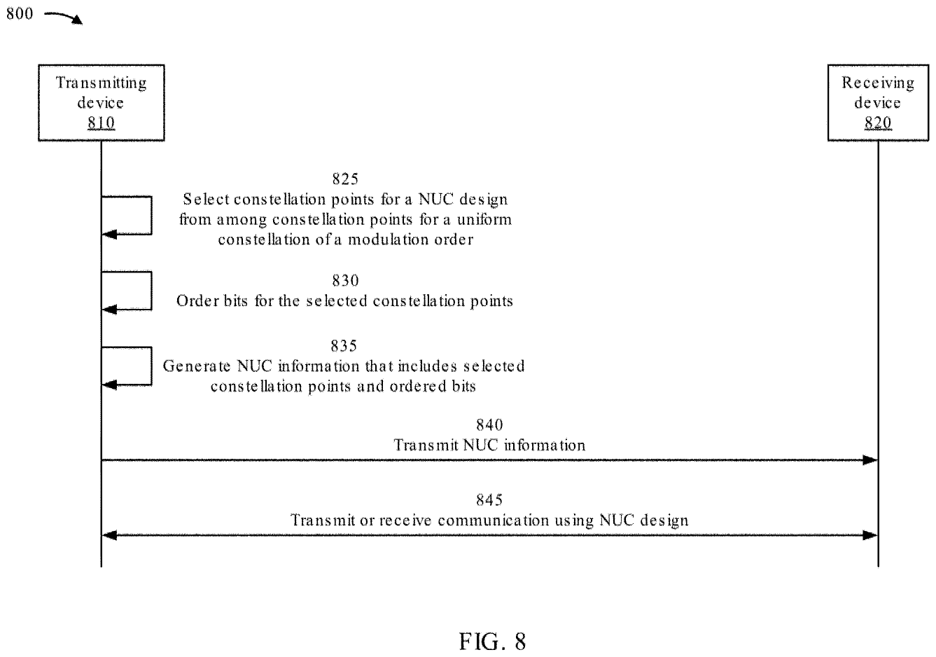

FIG. 8 is a diagram illustrating an example 800 associated with using an NUC design for a modulation order, in accordance with the present disclosure. As shown in FIG. 8, a transmitting device 810 (e.g., network node 110, UE 120) and a receiving device 820 (e.g., UE 120, network node 110) may communicate with one another via a wireless network (e.g., wireless network 100).

Example 800 shows use of an NUC design. As shown by reference number 825, the transmitting device 810 may select constellation points for an NUC design from among constellation points for a uniform constellation of a modulation order (e.g., QAM). For example, the transmitting device 810 may add a point of a random distribution to a constellation of a candidate NUC design and calculate the energy of the candidate constellation after each addition. The recently added point may be added to or rejected from the candidate constellation based at least in part on the calculated energy satisfying an energy threshold (e.g., minimum energy). The transmitting device 810 may select NUC points from a subset of the uniform constellation. This may include selecting NUC points from configured regions of the uniform constellation or by stopping the iterative building of the constellation of the NUC design. In some aspects, the transmitting device 810 may select the constellation points based at least in part on the BICM capacity of the system. For example, the selection and/or the bit labelling may be limited by the BICM capacity.

As shown by reference number 830, the transmitting device 810 may order bits for the selected constellation points. This may include assigning bits for the modulated data at constellation points. If a bit is high performance (e.g., one of top two bits for energy), the bit may become a system bit. System bits may be, for example, the first and second bits.

As shown by reference number 835, the transmitting device 810 may generate NUC information that indicates the NUC design. The NUC information may include the selected constellation points and ordered bits. The constellation points and the ordered bits may be conveyed in an LUT. The LUT may indicate a beam order and coordinates for each constellation point of the NUC design.

As shown by reference number 840, the transmitting device 810 may transmit the NUC information for the receiving device 820 to use for demodulation. As shown by reference number 845, the transmitting device 810 may transmit or receive a communication using the NUC design.

In some aspects, the transmitting device 810 may select constellation points for a second NUC design from among the constellation points for the same uniform constellation of the modulation order. The first NUC design may be associated with a first SNR, and the second NUC design may be associated with a second SNR.

As indicated above, FIG. 8 is provided as an example. Other examples may differ from what is described with respect to FIG. 8.

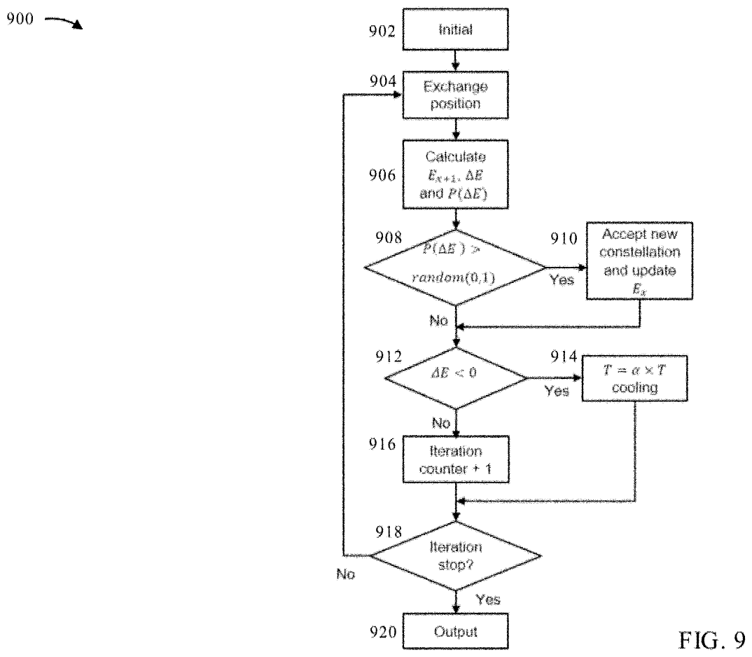

FIG. 9 is a diagram illustrating an example 900 of an NUC design search, in accordance with the present disclosure.

Example 900 shows an NUC design search that uses a simulated annealing (SA) algorithm. The SA algorithm, in this example, may use temperature T as a target value, including T_{f} for a final temperature from an initial temperature T₀. The SA algorithm may use a cooling parameter or and an energy function E( ) (e.g., BICM capacity). E( ) may be E(X), where X is a constellation points alphabet in the step x and thus Ex=E(X), ΔE=Eₓ₊₁−Eₓ, and

$$P ( Δ E ) = \{ \begin{matrix}1 , & Δ E < 0 \\ exp ( - \frac{Δ E}{kT} ) , & Δ E \geq 0\end{matrix} .$$

As shown by reference number 902, initially, the transmitting device 810 may use a randomly distributed constellation, set T=T₀, and calculate Eₓ.

As shown by reference number 904, where an iteration step starts, the transmitting device 810 may exchange a constellation point position. This may include randomly changing one point from the previous constellation. As shown by reference number 906, the transmitting device 810 may calculate Eₓ₊₁, ΔE, and P(ΔE). As shown by reference number 908, if P(ΔE)>random(0,1), the transmitting device 810 may accept the new constellation and update Eₓ. As shown by reference number 912, if ΔE<0, T=α×T cooling may occur, as shown by reference number 914. Otherwise, the iteration counter increments by 1, as shown by reference number 916. As shown by reference number 918, the iterations may stop when T<T_{f} or when the transmitting device reaches the maximum quantity of iterations. As shown by reference number 920, the new constellation may be output.

As indicated above, FIG. 9 is provided as an example. Other examples may differ from what is described with regard to FIG. 9.

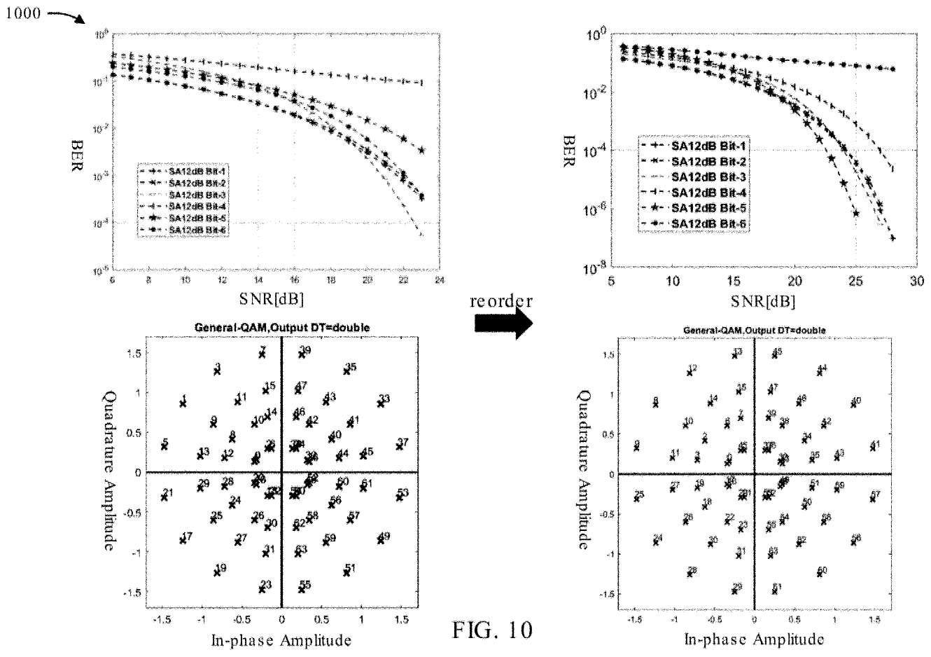

FIG. 10 is a diagram illustrating an example 1000 of bit reordering, in accordance with the present disclosure.

Elements of an NUC design may be reordered. In some aspects, bits for constellation points may be reordered based at least in part on bit performance. For example, with a system LDPC encoder, high performance bits may be set as system bits. For example, if a bit performance has a bit error rate (BER) that is low and an SNR that is high for two bits with respect to other bits, those two bits may become reordered to be system bits. System bits may be the first and second bits.

As indicated above, FIG. 10 is provided as an example. Other examples may differ from what is described with regard to FIG. 10.

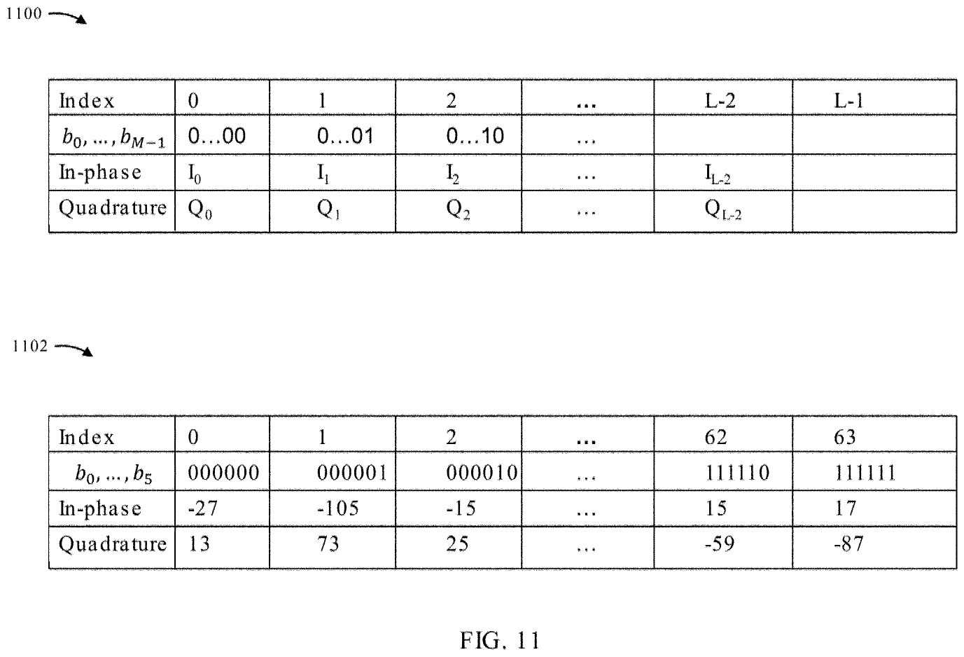

FIG. 11 is a diagram illustrating examples 1100 and 1102 of NUC LUTs, in accordance with the present disclosure.

Parameters for an LUT, such as in example 1100, may include NUC order L, and QAM lattice order L_{M}, where M=log 2(L). In the LUT, each point of an NUC design is indexed in the QAM grid, and the coordinates of in-phase and quadrature are included. Each point may include bits that are labeled for the point. Example 1102 shows an example of a 2D 64 NUC LUT optimized for an SNR of 12 decibels (dB).

As indicated above, FIG. 11 is provided as an example. Other examples may differ from what is described with regard to FIG. 11.

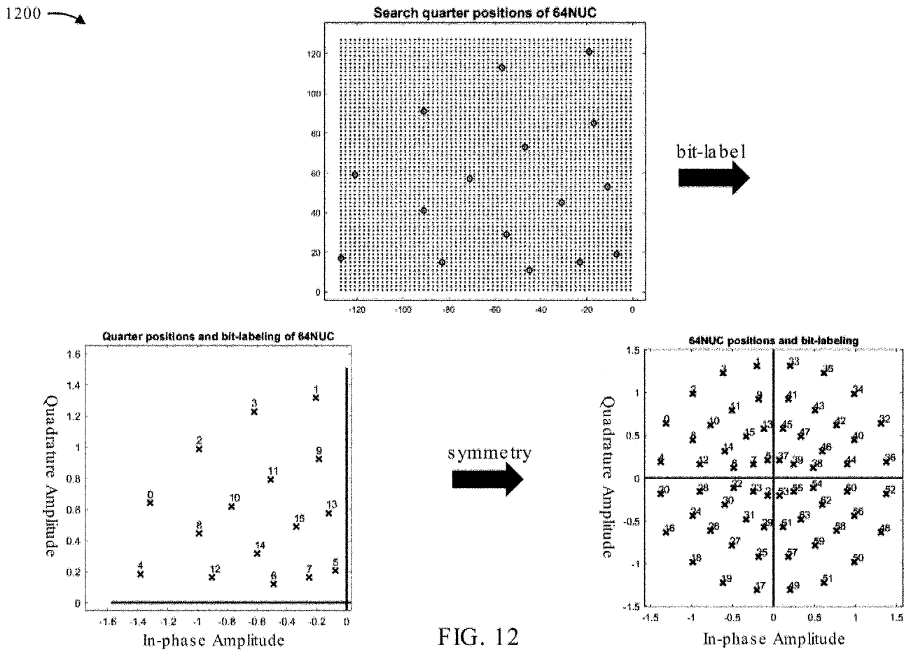

FIG. 12 is a diagram illustrating an example 1200 of NUC generation, in accordance with the present disclosure.

Example 1200 shows generation of a 64 constellation point NUC design. The transmitting device may search a quarter of placement positions of a uniform QAM lattice with, for example, 16,384 constellation points. The transmitting device may select 64 points for the NUC design. The transmitting device may then label the bits for the points. The transmitting device may then rearrange the points to be symmetrical in all positions with respect to the axes. This may include adjustments to the in-phase and quadrature coordinates. The transmitting device may reorder bits based at least in part on bit performance.

In some existing NUC schemes, there may be up to 6 decimal places for a constellation point. That is, one constellation point may be up to 36 bits for a binary value and thus 64 bits may involve over 2250 bits. This is a high level of complexity. However, in some aspects, an NUC design may include a search for 64 points from among a 128×128 QAM grid (16,384 points), or a quarter search in a 64×64 grid (4,096 points). The in-phase component index of constraint QAM grid may be a 6-bit binary value and the quadrature component index of constraint QAM grid may be a 6-bit binary value. One constellation point may use 12 bits for a binary value, where all 64 points may use about 750 bits. That is, the new NUC design scheme may use one-third of the storage of the existing NUC scheme. As a result, the new NUC design conserves processing resources and signaling resources. There may be minimum changes for the modulation by reusing the NR LDPC as much as possible. Some components may be added before and after the mapper and de-mapper, without altering the other blocks.

As indicated above, FIG. 12 is provided as an example. Other examples may differ from what is described with regard to FIG. 12.

FIG. 13 is a diagram illustrating an example process 1300 performed, for example, by a transmitting device, in accordance with the present disclosure. Example process 1300 is an example where the transmitting device (e.g., UE 120, network node 110, transmitting device 810) performs operations associated with NUC designs.

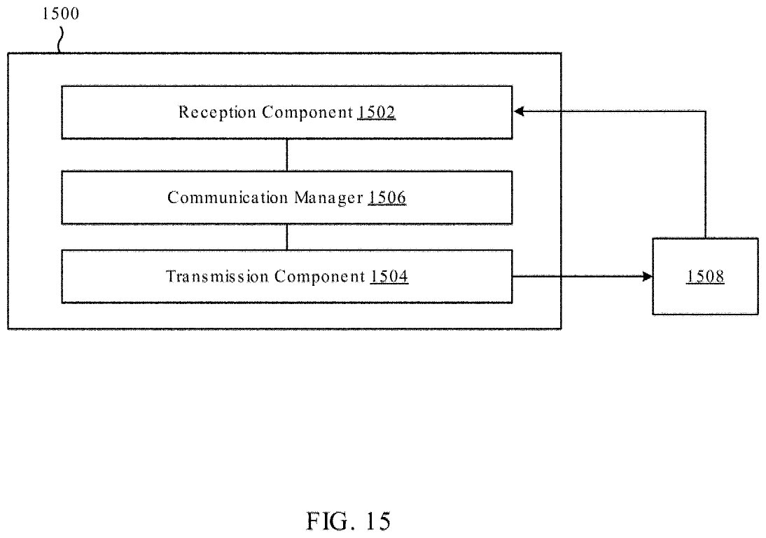

As shown in FIG. 13, in some aspects, process 1300 may include selecting constellation points for a first NUC design from among constellation points for a uniform constellation of a modulation order (block 1310). For example, the transmitting device (e.g., using communication manager 1506 depicted in FIG. 15) may select constellation points for a first NUC design from among constellation points for a uniform constellation of a modulation order, as described above.

As further shown in FIG. 13, in some aspects, process 1300 may include ordering bits for the selected constellation points (block 1320). For example, the transmitting device (e.g., using communication manager 1506 depicted in FIG. 15) may order bits for the selected constellation points, as described above.

As further shown in FIG. 13, in some aspects, process 1300 may include generating NUC information that includes the selected constellation points and the ordered bits (block 1330). For example, the transmitting device (e.g., using communication manager 1506 depicted in FIG. 15) may generate NUC information that includes the selected constellation points and the ordered bits, as described above.

As further shown in FIG. 13, in some aspects, process 1300 may include transmitting the NUC information (block 1340). For example, the transmitting device (e.g., using transmission component 1504 and/or communication manager 1506 depicted in FIG. 15 depicted in FIG. 15) may transmit the NUC information, as described above.

Process 1300 may include additional aspects, such as any single aspect or any combination of aspects described below and/or in connection with one or more other processes described elsewhere herein.

In a first aspect, process 1300 includes transmitting a communication using the first NUC design.

In a second aspect, alone or in combination with the first aspect, the modulation order is a quadrature amplitude modulation.

In a third aspect, alone or in combination with one or more of the first and second aspects, the NUC information includes a look-up table that indicates a beam order and coordinates for each constellation point of the first NUC design.

In a fourth aspect, alone or in combination with one or more of the first through third aspects, selecting the constellation points for the first NUC design includes selecting the constellation points for the first NUC design based at least in part on a BICM capacity.

In a fifth aspect, alone or in combination with one or more of the first through fourth aspects, ordering the bits includes labelling the bits based at least in part on the BICM capacity.

In a sixth aspect, alone or in combination with one or more of the first through fifth aspects, process 1300 includes selecting constellation points for a second NUC design from among the constellation points for the uniform constellation of the modulation order.

In a seventh aspect, alone or in combination with one or more of the first through sixth aspects, the first NUC design is associated with a first signal-to-noise ratio (SNR), and the second NUC design is associated with a second SNR.

In an eighth aspect, alone or in combination with one or more of the first through seventh aspects, ordering the bits includes reordering high performance bits as system bits.

In a ninth aspect, alone or in combination with one or more of the first through eighth aspects, process 1300 includes setting an NUC design order and a modulation order.

In a tenth aspect, alone or in combination with one or more of the first through ninth aspects, process 1300 includes selecting an SNR for the first NUC design.

In an eleventh aspect, alone or in combination with one or more of the first through tenth aspects, selecting the constellation points for the first NUC design includes selecting the constellation points from among a subset of the constellation points for the uniform constellation of the modulation order.

In a twelfth aspect, alone or in combination with one or more of the first through eleventh aspects, a quantity of the subset of the constellation points is equal to or less than 25% of a quantity of the constellation points for the uniform constellation of the modulation order.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a receiving device, in accordance with the present disclosure. Example process 1400 is an example where the receiving device (e.g., UE 120, network node 110, receiving device 820) performs operations associated with NUC designs.

As shown in FIG. 14, in some aspects, process 1400 may include receiving NUC information that includes ordered bits and coordinates for constellation points selected for a first NUC design from among constellation points for a uniform constellation of a modulation order (block 1410). For example, the receiving device (e.g., using reception component 1502 and/or communication manager 1506 depicted in FIG. 15) may receive NUC information that includes ordered bits and coordinates for constellation points selected for a first NUC design from among constellation points for a uniform constellation of a modulation order, as described above.

As further shown in FIG. 14, in some aspects, process 1400 may include transmitting or receiving a communication using the first NUC design (block 1420). For example, the receiving device (e.g., using transmission component 1504 and/or communication manager 1506 depicted in FIG. 15) may transmit or receive a communication using the first NUC design, as described above.

Process 1400 may include additional aspects, such as any single aspect or any combination of aspects described below and/or in connection with one or more other processes described elsewhere herein.

In a first aspect, the modulation order is a quadrature amplitude modulation.

In a second aspect, alone or in combination with the first aspect, the NUC information includes a look-up table that indicates a beam order and coordinates for each constellation point of the first NUC design.

In a third aspect, alone or in combination with one or more of the first and second aspects, the NUC information indicates a second NUC design from among the constellation points for the uniform constellation of the modulation order.

In a fourth aspect, alone or in combination with one or more of the first through third aspects, the first NUC design is associated with a first SNR, and the second NUC design is associated with a second SNR.

In a fifth aspect, alone or in combination with one or more of the first through fourth aspects, the constellation points for the first NUC design are selected from among a subset of the constellation points for the uniform constellation of the modulation order.

In a sixth aspect, alone or in combination with one or more of the first through fifth aspects, a quantity of the subset of the constellation points is equal to or less than 25% of a quantity of the constellation points for the uniform constellation of the modulation order.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a transmitting device or a receiving device, or a transmitting device or a receiving device may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 1506 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 1-12. Additionally, or alternatively, the apparatus 1500 may be configured to perform one or more processes described herein, such as process 1300 of FIG. 13, process 1400 of FIG. 14, or a combination thereof. In some aspects, the apparatus 1500 and/or one or more components shown in FIG. 15 may include one or more components of the transmitting device or receiving device described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the transmitting device or receiving device described in connection with FIG. 2.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, a modem, a modulator, a transmit MIMO processor, a transmit processor, a controller/processor, a memory, or a combination thereof, of the transmitting device or receiving device described in connection with FIG. 2. In some aspects, the transmission component 1504 may be co-located with the reception component 1502 in a transceiver.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

In some aspects associated with a transmitting device, the communication manager 1506 may select constellation points for a first NUC design from among constellation points for a uniform constellation of a modulation order. The communication manager 1506 may order bits for the selected constellation points. The communication manager 1506 may generate NUC information that includes the selected constellation points and the ordered bits. The transmission component 1504 may transmit the NUC information.

The transmission component 1504 may transmit a communication using the first NUC design. The communication manager 1506 may select constellation points for a second NUC design from among the constellation points for the uniform constellation of the modulation order. The communication manager 1506 may set an NUC design order and a modulation order. The communication manager 1506 may select an SNR for the first NUC design.

In some aspects associated with a receiving device, the reception component 1502 may receive NUC information that includes ordered bits and coordinates for constellation points selected for a first NUC design from among constellation points for a uniform constellation of a modulation order. The transmission component 1504 may transmit or receive a communication using the first NUC design.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a transmitting device, comprising: selecting constellation points for a first non-uniform constellation (NUC) design from among constellation points for a uniform constellation of a modulation order; ordering bits for the selected constellation points; generating NUC information that includes the selected constellation points and the ordered bits; and transmitting the NUC information.

Aspect 2: The method of Aspect 1, further comprising transmitting a communication using the first NUC design.

Aspect 3: The method of any of Aspects 1-2, wherein the modulation order is a quadrature amplitude modulation.

Aspect 4: The method of any of Aspects 1-3, wherein the NUC information includes a look-up table that indicates a beam order and coordinates for each constellation point of the first NUC design.

Aspect 5: The method of any of Aspects 1-4, wherein selecting the constellation points for the first NUC design includes selecting the constellation points for the first NUC design based at least in part on a bit-interleaved coded modulation (BICM) capacity.

Aspect 6: The method of Aspect 5, wherein ordering the bits includes labelling the bits based at least in part on the BICM capacity.

Aspect 7: The method of any of Aspects 1-6, further comprising selecting constellation points for a second NUC design from among the constellation points for the uniform constellation of the modulation order.

Aspect 8: The method of Aspect 7, wherein the first NUC design is associated with a first signal-to-noise ratio (SNR), and the second NUC design is associated with a second SNR.

Aspect 9: The method of any of Aspects 1-8, wherein ordering the bits includes reordering high performance bits as system bits.

Aspect 10: The method of any of Aspects 1-9, further comprising setting an NUC design order and a modulation order.

Aspect 11: The method of any of Aspects 1-10, further comprising selecting a signal-to-noise ratio (SNR) for the first NUC design.

Aspect 12: The method of any of Aspects 1-11, wherein selecting the constellation points for the first NUC design includes selecting the constellation points from among a subset of the constellation points for the uniform constellation of the modulation order.

Aspect 13: The method of Aspect 12, wherein a quantity of the subset of the constellation points is equal to or less than 25% of a quantity of the constellation points for the uniform constellation of the modulation order.

Aspect 14: A method of wireless communication performed by a receiving device, comprising: receiving non-uniform constellation (NUC) information that includes ordered bits and coordinates for constellation points selected for a first NUC design from among constellation points for a uniform constellation of a modulation order; and transmitting or receiving a communication using the first NUC design.

Aspect 15: The method of Aspect 14, wherein the modulation order is a quadrature amplitude modulation.

Aspect 16: The method of any of Aspects 14-15, wherein the NUC information includes a look-up table that indicates a beam order and coordinates for each constellation point of the first NUC design.

Aspect 17: The method of any of Aspects 14-16, wherein the NUC information indicates a second NUC design from among the constellation points for the uniform constellation of the modulation order.

Aspect 18: The method of Aspect 17, wherein the first NUC design is associated with a first signal-to-noise ratio (SNR), and the second NUC design is associated with a second SNR.

Aspect 19: The method of any of Aspects 14-18, wherein the constellation points for the first NUC design are selected from among a subset of the constellation points for the uniform constellation of the modulation order.

Aspect 20: The method of Aspect 19, wherein a quantity of the subset of the constellation points is equal to or less than 25% of a quantity of the constellation points for the uniform constellation of the modulation order.

Aspect 21: An apparatus for wireless communication at a device, comprising a processor; memory coupled with the processor; and instructions stored in the memory and executable by the processor to cause the apparatus to perform the method of one or more of Aspects 1-20.

Aspect 22: A device for wireless communication, comprising a memory and one or more processors coupled to the memory, the one or more processors configured to perform the method of one or more of Aspects 1-20.

Aspect 23: An apparatus for wireless communication, comprising at least one means for performing the method of one or more of Aspects 1-20.

Aspect 24: A non-transitory computer-readable medium storing code for wireless communication, the code comprising instructions executable by a processor to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A transmitting device for wireless communication, comprising:
a memory; and
one or more processors, coupled to the memory, configured to:
select constellation points for a first non-uniform constellation (NUC) design from among constellation points for a uniform constellation of a modulation order;
order bits for the selected constellation points;
generate NUC information that includes the selected constellation points and the ordered bits; and
transmit the NUC information.

2. The transmitting device of claim 1, wherein the one or more processors are configured to transmit a communication using the first NUC design.

3. The transmitting device of claim 1, wherein the modulation order is a quadrature amplitude modulation.

4. The transmitting device of claim 1, wherein the one or more processors, to select the constellation points for the first NUC design, are configured to select the constellation points from among a subset of the constellation points for the uniform constellation of the modulation order.

5. The transmitting device of claim 4, wherein a quantity of the subset of the constellation points is equal to or less than 25% of a quantity of the constellation points for the uniform constellation of the modulation order.

6. The transmitting device of claim 1, wherein the NUC information includes a look-up table that indicates a beam order and coordinates for each constellation point of the first NUC design.

7. The transmitting device of claim 1, wherein the one or more processors, to select the constellation points for the first NUC design, are configured to select the constellation points for the first NUC design based at least in part on a bit-interleaved coded modulation (BICM) capacity.

8. The transmitting device of claim 7, wherein the one or more processors, to order the bits, are configured to label the bits based at least in part on the BICM capacity.

9. The transmitting device of claim 1, wherein the one or more processors are configured to select constellation points for a second NUC design from among the constellation points for the uniform constellation of the modulation order.

10. The transmitting device of claim 9, wherein the first NUC design is associated with a first signal-to-noise ratio (SNR), and the second NUC design is associated with a second SNR.

11. The transmitting device of claim 1, wherein the one or more processors, to order the bits, are configured to reorder high performance bits as system bits.

12. The transmitting device of claim 1, wherein the one or more processors are further configured to set an NUC design order and a modulation order.

13. The transmitting device of claim 1, wherein the one or more processors are configured to select a signal-to-noise ratio (SNR) for the first NUC design.

14. A receiving device for wireless communication, comprising:
a memory; and
one or more processors, coupled to the memory, configured to:
receive non-uniform constellation (NUC) information that includes ordered bits and coordinates for constellation points selected for a first NUC design from among constellation points for a uniform constellation of a modulation order; and
transmit or receive a communication using the first NUC design.

15. The receiving device of claim 14, wherein the modulation order is a quadrature amplitude modulation.

16. The receiving device of claim 14, wherein the constellation points for the first NUC design are selected from among a subset of the constellation points for the uniform constellation of the modulation order.

17. The receiving device of claim 16, wherein a quantity of the subset of the constellation points is equal to or less than 25% of a quantity of the constellation points for the uniform constellation of the modulation order.

18. The receiving device of claim 14, wherein the NUC information includes a look-up table that indicates a beam order and coordinates for each constellation point of the first NUC design.

19. The receiving device of claim 14, wherein the NUC information indicates a second NUC design from among the constellation points for the uniform constellation of the modulation order.

20. The receiving device of claim 19, wherein the first NUC design is associated with a first signal-to-noise ratio (SNR), and the second NUC design is associated with a second SNR.

21.-30. (canceled)
